(19) United States
(12) Patent Application Publication
(10) Pub. No.: US 2020/0199810 A1
(43) Pub. Date: Jun. 25, 2020

(54) INTERIOR TRIM SURFACE MATERIAL

(71) Applicant: JAPAN VILENE COMPANY, LTD., Tokyo (JP)

(72) Inventors: Shinsuke MINAMIDE, Shiga (JP); Masashi YAGI, Shiga (JP)

(73) Assignee: JAPAN VILENE COMPANY, LTD., Tokyo (JP)

(21) Appl. No.: 16/613,045

(22) PCT Filed: May 16, 2018
(86) PCT No.: PCT/JP2018/018964

§ 371 Date: Nov. 12, 2019

(30) Foreign Application Priority Data
May 19, 2017 (JP) 2017-099574

(51) Int. Cl. D06M 15/263; D04H 1/64; D04H 1/49; C09D 11/104; C09D 11/023

(52) U.S. Cl. CPC D06M 15/263; D04H 1/64; C09D 11/023; C09D 11/104; D04H 1/49

(57) ABSTRACT

The object of the present invention is to provide an interior trim surface material with a more excellent texture. The interior trim surface material of the present invention comprises a print layer on at least one main surface of a fiber aggregate, and has a main surface (a main surface on which the print layer is exposed in the interior trim surface material) with a surface roughness (SMD) of less than 2.71 μm and an average frictional coefficient (MIU) of more than 0.27. When these conditions are satisfied, it is possible to provide an interior trim surface material that has an excellent texture, such as a feeling of high moistness, while still imparting a sensation that feels smooth and fine texture. Further, the interior trim surface material of the present invention comprises a print layer containing hollow particles having an average particle size of 106 μm or less, whereby a feeling of resistance or sliminess is imparted, thereby achieving an interior trim surface material with a more excellent texture, such as a feeling of high moistness.

### TECHNICAL FIELD

The invention relates to an interior trim surface material.

### BACKGROUND ART

Conventionally, fiber aggregates (for example, fiber webs, nonwoven fabrics, woven fabrics, knitted fabrics, or the like) have been used as components of interior trim surface materials in automobiles.

As interior trim surface materials comprising a fiber aggregate, the applicant proposed “an interior trim surface material obtained by needle-punching a fiber web on its one surface, impregnating the needle-punched surface with a binder, calendering the surface, and impregnating the opposite side of the needle-punched surface with a binder with a reduced tack” (Patent literature 1), and “an automotive interior trim surface material, wherein the raising of fibers on one surface of a needle-punched nonwoven fabric, and a resin is impregnated into the surface” (Patent literature 2).

However, these interior trim surface materials had a problem of inadequate texture.

As an interior trim surface material with excellent texture, for example, Patent literature 3 discloses synthetic leather that can be used for automobile interior materials, wherein the surface roughness (SMD) is 2.5 μm or less, and the average surface frictional coefficient (MIU) is 0.20 or more, and a resin layer containing organic microparticles, and inorganic microparticles with an average particle size of 50 nm to 800 nm is provided as the outermost skin of a nonwoven fabric or a woven or knitted fabric.

It is disclosed in Patent literature 3 that the synthetic skin imparts a sensation that feels smooth and fine texture due to a surface roughness (SMD) of 2.5 μm or less, and that the synthetic skin has a surface with a feeling of high moistness by imparting a feeling of resistance or sliminess due to an average surface frictional coefficient (MIU) of 0.20 or more.

### CITATION LIST

### Patent Literature

[Patent literature 1] Japanese Unexamined Patent Publication (Kokai) No. 62-257472
[Patent literature 2] Japanese Unexamined Patent Publication (Kokai) No. 09-137372
[Patent literature 3] Japanese Unexamined Patent Publication (Kokai) No. 2014-145133

### SUMMARY OF INVENTION

### Technical Problem

Recently however, interior trim surface materials with a more excellent texture have been demanded, and only the conventional technology disclosed in Patent literature 3 is considered to have a limit in providing an interior trim surface material that satisfies the demand.

Therefore, in order to provide an interior trim surface material with a more excellent texture, it was necessary to provide an interior trim surface material with a new structure that can improve the texture.

The present invention has been made to achieve such an object, which is to provide an interior trim surface material with a more excellent texture.

### Solution to Problem

The present invention is “an interior trim surface material comprising a print layer on at least one main surface of a fiber aggregate, characterized in that the main surface on which the print layer is exposed in the interior trim surface material has a surface roughness (SMD) of less than 2.71 μm and an average frictional coefficient (MIU) of more than 0.27, and the print layer contains hollow particles having an average particle size of 106 μm or less”.

### Advantageous Effects of Invention

The interior trim surface material of the present invention is an interior trim surface material with a print layer on at least one main surface of a fiber aggregate, and has a main surface (a main surface on which the print layer is exposed in the interior trim surface material) with a surface roughness (SMD) of less than 2.71 μm and an average frictional coefficient (MIU) of more than 0.27, as measured with a surface tester (KES-FB4). That is to say, the fact that the surface roughness (SMD) is small means that the interior trim surface material has a smooth main surface, and the fact that the average frictional coefficient (MIU) is large means that the interior trim surface material has a flexible main surface.

When these conditions are satisfied, it is possible to provide an interior trim surface material that has an excellent texture, such as a feeling of high moistness, while still imparting a sensation that feels smooth and fine texture.

Further, the interior trim surface material of the present invention comprises a print layer containing hollow particles having an average particle size of 106 μm or less, whereby a feeling of resistance or sliminess is imparted, thereby achieving an interior trim surface material with a more excellent texture, such as a feeling of high moistness.

The reason why this structure can provide an interior trim surface material with a more excellent texture is not completely clear, but this is thought to be due to the following effects.

Non-patent literature “Shinichi WATANABE et al., “syoku-kankaku ni yoru ryushi-gun no ninshiki to gengo hyouka (Recognition and language estimation of fine particles through tactile sensing with fingers)”, Journal of the Japan Society for Precision Engineering, published on November 2005, Vol. 71, PP. 1421-1425″ discloses finding that particles with an average particle size of 106 μm, and particles with an smaller average particle size easily get into the fingerprint of human fingers, and easily get caught in the fingerprint of the human fingers.

Therefore, when humans touch a main surface containing hollow particles with an average particle size of 106 μm or less, the hollow particles exposed on the main surface easily get into the fingerprints of fingers of the humans who are touching them, and easily get caught in the fingerprints of the human fingers. As a result, the humans feel resistance because their fingers are difficult to slide on the main surface of the interior trim surface material.

Hollow particles are easier to deform in the particle diameter direction than solid particles.

Therefore, when humans touch a main surface containing hollow particles, the main surface and the hollow particles exposed on the main surface easily deform following the movement of fingers of the humans who are touching them. As a result, since the humans feel the tactile sensation when touching something that has elasticity, but not the tactile sensation when touching a hard object, the humans feel resistance because their fingers are difficult to slide on the main surface of the interior trim surface material, and simultaneously, the humans feel sliminess as if the main surface shape clings following the finger pressure.

As described above, while still imparting a sensation that feels smooth and fine texture, the interior trim surface material is one with a more excellent texture, such as a feeling of high moistness, by imparting a feeling of resistance or sliminess.

### DESCRIPTION OF EMBODIMENTS

In the present invention, various embodiments, such as embodiments described below, can be appropriately selected.

The interior trim surface material of the present invention has a structure comprising a fiber aggregate, and a print layer on a main surface of the fiber aggregate.

The term “fiber aggregate” as used herein means a sheet fabric, such as a fiber web, a nonwoven fabric, a woven fabric, a knitted fabric, or the like. Since the interior trim surface material of the present invention comprises the fiber aggregate (in particular, a nonwoven fabric), it is flexible, and has a more excellent texture, such as a feeling of high moistness, by imparting a feeling of resistance or sliminess. The interior trim surface material comprising a fiber aggregate (in particular, a nonwoven fabric) in which all constituent fibers are randomly entangled to each other is preferable, because it is more flexible, and has a more excellent texture, such as a feeling of high moistness, by imparting a feeling of resistance or sliminess.

Further, since the interior trim surface material of the present invention comprises the fiber aggregate, it is flexible and has excellent followability to a mold. In particular, when the fiber aggregate constituting the interior trim surface material of the present invention is a nonwoven fabric (in particular, a nonwoven fabric in which all constituent fibers are randomly entangled to each other), it is preferable, because it is more flexible, and has more excellent followability to a mold.

The constituent fibers of the fiber aggregate can be constructed using known organic resins, for example, polyolefin resins (for example, polyethylene, polypropylene, polymethylpentene, polyolefin resins having a structure in which a part of hydrocarbon is substituted with cyano groups, or halogens such as fluorine or chlorine, or the like), styrene resins, polyvinyl alcohol resins, polyether resins (for example, polyether ether ketone, polyacetal, modified polyphenylene ether, aromatic polyether ketone, or the like), polyester resins (for example, polyethylene terephthalate, polytrimethylene terephthalate, polybutylene terephthalate, polyethylene naphthalate, polybutylene naphthalate, polycarbonate, polyarylate, wholly aromatic polyester resins, or the like), polyimide resins, polyamideimide resins, polyamide resins (for example, aromatic polyamide resins, aromatic polyetheramide resins, nylon resins, or the like), resins having nitrile groups (for example, polyacrylonitrile, or the like), urethane resins, epoxy resins, polysulfone resins (for example, polysulfone, polyethersulfone, or the like), fluorine resins (for example, polytetrafluoroethylene, polyvinylidene fluoride, or the like), cellulosic resins, polybenzimidazole resins, acrylic resins (for example, polyacrylonitrile resins copolymerized with acrylic ester or methacrylic ester, modacrylic resins obtained by copolymerization of acrylonitrile with vinyl chloride or vinylidene chloride, or the like), or the like.

These organic resins may be linear polymers or branched polymers, and may be block copolymers or random copolymers, and the three-dimensional structure and the presence or absence of crystallinity in these organic resins are not particularly limited. Further, multi-component organic resins may be mixed.

When the interior trim surface material is required to be flame-retardant, it is preferable that the constituent fibers of the fiber aggregate contain a flame-retardant organic resin. Examples of the flame-retardant organic resin include modacrylic resins, vinylidene resins, polyvinyl chloride resins, polyvinylidene fluoride resins, novoloid resins, polyclar resins, polyester resins copolymerized with a phosphorus compound, acrylic resins copolymerized with halogen-containing monomers, aramid resins, resins kneaded with a halogen based-, a phosphorus based-, or a metallic compound based-flame retardant, and the like. The constituent fibers of the fiber aggregate may be fibers kneaded with a pigment, or spun-dyed fibers, such as dyed fibers or the like.

The interior trim surface material may be one that carries a flame-retardant with a binder or the like.

The constituent fibers may be obtained by a known method, for example, a melt spinning method, a dry spinning method, a wet spinning method, a direct spinning method (a melt blow method, a spunbond method, an electrostatic spinning method, or the like), a method of extracting fibers with a small fiber diameter by removing one or more types of resin components from composite fibers, a method of obtaining split fibers by beating fibers, or the like.

The constituent fibers may be composed of one type of organic resin, or may be composed of multiple types of organic resins. The constituent fibers composed of multiple types of organic resins may be, for example, a core-sheath type, a sea-island type, a side-by-side type, an orange type, a bimetal type, or the like, which are commonly called a composite fiber.

The constituent fibers may contain nonconventional cross-section fibers, in addition to substantially circular fibers and elliptical fibers. The nonconventional cross-section fibers may have a fiber cross-section of a hollow shape, a polygonal shape such as a triangle shape, an alphabet letter shape such as a Y shape, an irregular shape, a multi-leaf shape, a symbol shape such as an asterisk shape, a shape in which these shapes combine, or the like.

It is preferable that the fiber aggregate contains heat-fusible fibers as the constituent fibers, because by heat-fusing the fibers, the strength and shape stability are imparted to the fiber aggregate, and fuzzing and fiber scattering can be suppressed. Such heat-fusible fibers may be all-fusion-type heat-fusible fibers, or partial-fusion-type heat-fusible fibers, such as the composite fibers as described above. Heat-fusible fibers containing, for example, a low melting point polyolefin resin or a low melting point polyester resin as a component (organic resin) that exhibits heat-fusibility in the heat-fusible fibers may be appropriately selected.

It is preferable that the fiber aggregate contains crimpable fibers, because stretchability increases, and followability to a mold is excellent. As such crimpable fibers, for example, crimpable fibers that develop crimps of latent crimpable fibers, fibers having crimps, or the like may be used.

Further, latent crimpable fibers that develop crimps by heating the fiber aggregate may be contained.

When the fiber aggregate is a fiber web or a nonwoven fabric, it can be prepared by, for example, a dry method in which the fibers described above are subjected to a card machine or an air-laying machine to entangle the fibers, a wet method in which the fibers are dispersed in a solvent, and made into a sheet to entangle the fibers, a method in which fibers are collected while spinning by a direct spinning method (a melt blow method, a spunbond method, an electrostatic spinning method, a spinning method by discharging a spinning solution and a gas flow in parallel (for example, a method disclosed in JP 2009-287138), or the like), or the like.

A nonwoven fabric can be prepared by entangling and/or unifying the constituent fibers of a prepared fiber web. As a method of entangling and/or unifying the constituent fibers, for example, a method of entangling fibers by needles or a water flow, a method in which the fiber web is subjected to a heat treatment or the like to bonding-unify or melting-unify the constituent fibers with a binder or adhesive fibers, or the like, may be exemplified.

A method for heat treatment may be appropriately selected, and for example, a method of heating or heating and pressing with rolls, a method of heating using a heating machine such as an oven dryer, a far-infrared heater, a dry heat dryer, a hot air dryer, or the like, a method of heating a contained organic resin by irradiating infrared rays under no pressure, or the like, may be used.

The type of a binder that can be used is appropriately selected, and for example, polyolefin (modified polyolefin or the like), ethylene-vinyl alcohol copolymer, ethylene-acrylate copolymer such as ethylene-ethyl acrylate copolymer or the like, various rubbers and their derivatives (styrene-butadiene rubber (SBR), fluoro rubber, urethane rubber, ethylene-propylene-diene rubber (EPDM), or the like), cellulose derivatives (carboxymethyl cellulose (CMC), hydroxyethyl cellulose, hydroxypropyl cellulose, or the like), polyvinyl alcohol (PVA), polyvinyl butyral (PVB), polyvinyl pyrrolidone (PVP), polyurethane, epoxy resin, polyvinylidene fluoride (PVdF), vinylidene fluoride-hexafluoropropylene copolymer (PVdF-HFP), acrylic resins, or the like, may be used.

It is preferable that the binder contains an acrylic resin, because the binder moderately softens during heat molding such as heat press using a mold, and therefore, an interior trim surface material with excellent followability to a mold can be provided.

In addition to the resin described above, the binder may contain additives, such as a flame retardant, a fragrance, a pigment, an antibacterial agent, an antifungal agent, photocatalyst particles, an emulsifier, a dispersant, a surfactant, or the like.

The mass per unit area of the binder contained in the fiber aggregate is appropriately selected, and is preferably 2 g/m² or more, because the greater the amount of binder, the easier it is to provide an interior trim surface material with a smooth main surface (a surface roughness (SMD) of less than 2.71 μm). On the other hand, because when the amount of binder is excessively large, an interior trim surface material with poor flexibility on the main surface (an average frictional coefficient (MIU) of 0.27 or less) may be caused, and therefore, the mass per unit area of the binder is preferably 50 g/m² or less, preferably 30 g/m² or less, and preferably 20 g/m² or less. Each lower limit and each upper limit can be arbitrarily combined as desired.

When the fiber aggregate is a woven fabric or a knitted fabric, such a woven fabric or knitted fabric can be prepared by weaving or knitting the fibers as described above.

In addition to the fiber web, a fiber aggregate such as a nonwoven fabric, a woven fabric, a knitted fabric, or the like, may be subjected to the above-described method of entangling and/or unifying the constituent fibers.

The fineness of the constituent fibers of the fiber aggregate is not particularly limited, but it is preferably 1 dtex or more, more preferably 1.5 dtex or more, and still more preferably 2 dtex or more so as to provide an interior trim surface material with excellent rigidity. On the other hand, the fineness is preferably 100 dtex or less, more preferably 50 dtex or less, still more preferably 30 dtex or less, and still more preferably 10 dtex or less, so as to be an interior trim surface material capable of preparing an interior material with a smooth main surface due to a uniform texture. Each lower limit and each upper limit can be arbitrarily combined as desired.

The fiber length of the constituent fibers of the fiber aggregate is not particularly limited, but it is preferably 20 mm or more, more preferably 25 mm or more, and still more preferably 30 mm or more, from the viewpoint of rigidity. On the other hand, the fiber length is preferably 110 mm or less, and more preferably 60 mm or less, because if the fiber length exceeds 110 mm, a fiber lump tends to be formed during preparation of the fiber aggregate, and it may be difficult to provide an interior trim surface material with a smooth main surface. Each lower limit and each upper limit can be arbitrarily combined as desired.

The term “fiber length” as used herein means a value measured in accordance with JIS L1015(2010), 8.4.1c) direct method (C method).

Physical properties such as thickness, mass per unit area, or the like are not particularly limited, and may be appropriately adjusted.

The thickness of the fiber aggregate is preferably 0.5 to 5 mm, more preferably 1 to 3 mm, and still more preferably 1.1 to 1.9 mm. Each lower limit and each upper limit can be arbitrarily combined as desired.

The mass per unit area of the fiber aggregate is, for example, preferably 50 to 500 g/m², more preferably 80 to 300 g/m², still more preferably 100 to 250 g/m². Each lower limit and each upper limit can be arbitrarily combined as desired.

The term “thickness” as used herein means a vertical length when a compression load of 20 g/cm² is applied vertically to the main surface. The term “mass per unit area” as used herein means mass per 1 m² on the surface having the largest area (main surface) of an object to be measured.

The term “print layer” as used herein means a layer that is present on a main surface of the fiber aggregate and contains a printing resin. In connection with this, the term “main surface” as used herein means a surface with the largest area among the surfaces of the fiber aggregate.

The printing resin that constitutes the print layer is a resin that plays a role for carrying hollow particles. The printing resin can be appropriately selected, and the same resin as the binder described above can be used. In particular, it is preferable that the printing resin that constitutes the print layer contains an acrylic resin, because the print resin moderately softens during heat molding such as heat press using a mold, and therefore, an interior trim surface material with excellent followability to a mold can be provided.

In addition to the print resin, the print layer may contain additives, such as a flame retardant, a fragrance, a pigment, an antibacterial agent, an antifungal agent, photocatalyst particles, an emulsifier, a dispersant, a surfactant, a thickener, or the like.

The embodiment of the print layer present on one main surface of the fiber aggregate may be appropriately selected, and the embodiment may be an embodiment in which the print layer is present so as to cover the entire main surface, or an embodiment in which a part of the main surface is covered so as to form a pattern with a design such as a lattice, or a pattern such as a line, dots, or an irregular shape. As the print layer, a layer containing one type of printing resin may be provided, or a plurality of layers containing one or multiple types of printing resins may be provided. More particularly, a plurality of print layers with the same or different patterns, printing resins, and/or contained substances may be provided.

The print layers may be present on both main surfaces of the fiber aggregate, so long as the print layer is present on one main surface of the fiber aggregate.

In addition to the embodiment in which the print layer is present only on the main surface, the print layer may be an embodiment in which a part of components (for example, a printing resin or the like) that constitute the print layer penetrates between constituent fibers of the fiber aggregate.

The mass per unit area of the print layer may be appropriately selected. It may be 2-50 g/m², and it may be 10-30 g/m². Each lower limit and each upper limit can be arbitrarily combined as desired.

The main surface on which the print layer is exposed in the interior trim surface material of the present invention has a surface roughness (SMD) of less than 2.71 μm and an average frictional coefficient of more than 0.27.

The surface roughness is literally unevenness on the main surface, that is, an indicator of smoothness. The present inventors found that when the surface roughness (SMD) is less than 2.71 μm, it can contribute to excellent texture.

Because a smaller surface roughness (SMD) value tends to be smoother and a more excellent texture, the surface roughness (SMD) is preferably 2.70 μm or less, more preferably 2.60 μm or less, still more preferably 2.50 μm or less, still more preferably 2.30 μm or less, still more preferably 2.25 μm or less, still more preferably 2.15 μm or less, and most preferably 2.10 μm or less. The lower limit of the surface roughness (SMD) is not particularly limited, but the lower limit is 0 μm, which indicates a surface roughness with no unevenness. Each lower limit and each upper limit can be arbitrarily combined as desired.

The surface roughness (SMD) is a value measured using a surface tester (KES-FB4, manufactured by KATO TECH CO., LTD.). It means an average deviation of surface roughness data measured by setting a surface material sample (20 cm square) on the tester with a load of 400 g, bringing a roughness contactor (using 0.5 mm wire, contact surface width: 5 mm) into contact with the sample while applying a weight of 10.0 g to the roughness contactor, and moving the sample at a speed of 1 mm/sec. The unit is μm.

The average frictional coefficient (MIU) is an indicator of flexibility of the interior trim surface material, and the present inventors found that when the average frictional coefficient (MIU) is more than 0.27, it can contribute to excellent texture. That is to say, the average frictional coefficient (MIU) is measured by bringing a friction contactor into contact with a surface material while applying weight to the friction contactor, and when the surface material is soft, the friction contactor sinks into the surface material, and when the surface material is moved in this state, the average frictional coefficient increases.

Because a larger average frictional coefficient (MIU) value tends to be more flexible and a more excellent texture, the average frictional coefficient (MIU) is preferably 0.30 or more, more preferably 0.31 or more, still more preferably 0.32 or more, and still more preferably 0.40 or more. On the other hand, because when the average frictional coefficient (MIU) is too large, the frictional resistance will be too strong, and therefore, there is a risk of losing texture, it is preferably 1.00 or less. Each lower limit and each upper limit can be arbitrarily combined as desired.

The average frictional coefficient (MIU; frictional coefficient) is an average value of μ (frictional coefficient) in a distance of 20 mm, measured using a surface tester (KES-FB4), and means an average value measured under the same conditions as those for measuring fluctuations of average frictional coefficient (MMD) described below.

Other physical properties of the main surface exposed on the print layer in the interior trim surface material may be appropriately selected, but for example, the fluctuations of average frictional coefficient (MMD) of the main surface is preferably 0.025 or less.

The fluctuations of average frictional coefficient (MMD) is a value determined by a measurement using a surface tester (KES-FB4). It means the uniformity of the main surface of the interior trim surface material, because it is measured by bringing a friction contactor into contact with the main surface of the interior trim surface material, moving the interior trim surface material, and performing the measurement in a state where the friction contactor is stroking the surface material.

The present inventors found that when the fluctuations of average frictional coefficient (MMD) is 0.025 or less, it can contribute to excellent texture. Because the smaller the fluctuations of average frictional coefficient (MMD), the more uniform the main surface tends to be and the more excellent the texture tends to be, the fluctuations of average frictional coefficient (MMD) is preferably 0.020 or less, and preferably 0.015 or less. The lower limit of the fluctuations of average frictional coefficient (MMD) is not particularly limited, but is ideally 0%, which indicates that the frictional coefficients are completely the same, and the main surface is uniform. Each lower limit and each upper limit can be arbitrarily combined as desired.

The fluctuations of average frictional coefficient (MMD) is a value measured using a surface tester (KES-FB4), and means an average deviation of μ (frictional coefficient) measured by setting a surface material sample (20 cm square) on the tester with a load of 400 g, bringing a friction contactor (10 mm×10 mm) into contact with the sample while applying a weight of 50 g to the friction contactor, and moving the sample at a speed of 1 mm/sec.

The print layer in the interior trim surface material of the present invention contains hollow particles having an average particle size of 106 μm or less.

The term “hollow particles” as used herein means particles with cavities inside. The term “average particle size” of the particles as used herein means a value calculated by the following method.

### (Calculation Method of Average Particle Size)

(1) Optical micrographs (200×) of a plurality of hollow particles placed under a room temperature (25° C.) atmosphere are taken, or optical micrographs (200×) of both main surfaces of an interior trim surface material placed under a room temperature (25° C.) atmosphere are taken.
(2) Ten particles are randomly selected from the photographs in which the presence of particles is confirmed.
(3) Each particle size of the 10 selected particles is calculated, and the average of the calculated values is regarded as the average particle size. In connection with this, the diameter of a circle having the same area as that of each particle in the photographs is calculated, and the diameter value is regarded as the particle size of the particle.

The average particle size of the hollow particles used in the present invention is 106 μm or less, but is preferably 85 μm or less, because the smaller the average particle size of the hollow particles, the more easily they get into the fingerprints of human fingers and get caught in the fingerprints of the human fingers. The lower limit of the average particle size may be appropriately selected, but it is ideally 30 μm or more. The average particle size of the hollow particles is preferably more than 35 μm, because according to the above-mentioned non-patent literature, if the average particle size of the hollow particles is too small, humans will have a dull sensation when touching the hollow particles exposed on the main surface, and the tactile improvement effect may be unintentionally reduced. Each lower limit and each upper limit can be arbitrarily combined as desired.

The coefficient of variation (hereinafter sometimes referred to as CV value) in particle size of the hollow particles contained in the print layer may be appropriately selected. Since the smaller the CV value, the narrower the distribution of hollow particles, an interior trim surface material with a more excellent texture can be provided efficiently as intended. For this reason, the CV value in particle size of the hollow particles is preferably 17% or less, and preferably 16% or less. The lower limit of the average particle size may be appropriately selected, but is ideally 0%. Each lower limit and each upper limit can be arbitrarily combined as desired.

The components of the hollow particles may be appropriately selected, and it is preferable that the components constituting the hollow particles include an organic resin so that the hollow particles are easily deformed in the particle diameter direction.

When hollow particles with a structure containing an organic resin and an inorganic component are used as hollow particles, it becomes easy to prepare a coating liquid in which hollow particles are uniformly dispersed in a dispersion medium. As a result, it is preferable, because the print layer in which hollow particles are uniformly distributed is provided by using such a coating liquid, and an interior trim surface material with a more excellent texture can be provided efficiently as intended.

When the hollow particles expand unintentionally during a heating process in the interior trim surface material preparation process, it may be difficult to provide an interior trim surface material with a print layer containing hollow particles having an average particle size of 106 μm or less.

Therefore, it is preferable that they are hollow particles whose particle size hardly changes within the heating temperature range in the interior trim surface material preparation process, more particularly, it is preferable that they are hollow particles whose particle size hardly changes even in an atmosphere with a heating temperature of 150° C.

The thermal expansion coefficient of hollow particles can be calculated from each average particle size under a heating temperature (150° C.) atmosphere and a room temperature (25° C.) atmosphere of hollow particles capable of constituting the interior trim surface material, or hollow particles collected from the interior trim surface material. That is, the thermal expansion coefficient of hollow particles can be calculated by calculating the percentage of an average particle size of hollow particles under a heating temperature (150° C.) atmosphere with respect to an average particle size of hollow particles under a room temperature (25° C.) atmosphere. More particularly, they are preferably hollow particles having a thermal expansion coefficient close to 100% (80% to 120%, and preferably 85% to 115%). Each lower limit and each upper limit can be arbitrarily combined as desired.

Concrete examples of hollow particles suitable for constituting the interior trim surface material of the present invention and satisfying the properties described above include MFL-81GTA, MFL-81GCA, MFL-SEVEN, MFL-HD30CA, MFL-HD60CA, MFL-100MCA, MFL-110CAL, and the like (Matsumoto Yushi-Seiyaku Co., Ltd.). These hollow particles are ones in which the surface of hollow microspheres made of an acrylonitrile copolymer is coated with inert inorganic powder (for example, calcium carbonate, talc, or titanium oxide).

Embodiments in which the print layer contains hollow particles may be appropriately selected, and it may be an embodiment in which hollow particles are present only on the main surface on which the print layer is exposed, or an embodiment in which hollow particles are present inside the print layer and on the main surface on which the print layer is exposed.

As the embodiment in which hollow particles are present on the main surface on which the print layer is exposed, for example, an embodiment in which hollow particles are bonded and supported by a printed resin on the main surface on which the print layer is exposed, an embodiment in which hollow particles are carried in a state that part of hollow particles sinks into the main surface on which the print layer is exposed, or the like, may be exemplified. It may be an embodiment in which part of hollow particles are exposed on the main surface of the print layer.

The amount of hollow particles contained in the print layer is appropriately selected, and it may be 15 g/m² or less, 12 g/m² or less, and 9 g/m² or less. On the other hand, the lower limit of the content may be appropriately adjusted, and it is preferably more than 1 g/m² so that an interior trim surface material with characteristics of the present invention can be provided. Each lower limit and each upper limit can be arbitrarily combined as desired.

In addition to hollow particles, the print layer may contain additives, such as a flame retardant, a fragrance, a pigment, an antibacterial agent, an antifungal agent, photocatalyst particles, an emulsifier, a dispersant, a surfactant, or the like.

Although the print layer may contain particles other than hollow particles in the present invention, it is preferable that the interior trim surface material is one with the print layer containing only the above-mentioned hollow particles, as particles, so that an interior trim surface material with a more excellent texture, such as a feeling of high moistness, by a feeling of resistance or sliminess is imparted, can be provided. In particular, it is more preferable that the interior trim surface material is one with the print layer containing only one type of hollow particles in the present invention, as particles, so that an interior trim surface material in which the above-mentioned effects were demonstrated efficiently can be provided.

The percentage of the solid content mass of hollow particles with respect to the solid content mass of print resin constituting the print layer may be appropriately adjusted, but it is preferably more than 25 mass %. When the percentage is more than 25 mass %, a feeling of high moistness can be imparted to humans by feeling a feeling of resistance or sliminess, and an interior trim surface material with a more excellent texture can be provided.

Therefore, the percentage is preferably 28 mass % or more, preferably 28 mass % or more, preferably 30 mass % or more, preferably 30 mass % or more, preferably 35 mass % or more, and preferably 40 mass % or more. The upper limit of the percentage may be appropriately selected, and it may be 400 mass % or less, 200 mass % or less, and 100 mass % or less. Each lower limit and each upper limit can be arbitrarily combined as desired.

The percentage of the solid content mass of hollow particles with respect to the solid content mass of print resin constituting the print layer can be calculated by rounding off the decimal point and less of a value calculated by the following method.

A=100×B/C

A: The percentage of the solid content mass of hollow particles with respect to the solid content mass of print resin constituting the print layer (unit: mass %)
B: The solid content mass of hollow particles constituting the print layer (unit: g/m²)
C: The solid content mass of print resin constituting the print layer (unit: g/m²)

When it is difficult to measure the solid content mass of hollow particles and print resin constituting the print layer of the interior trim surface material, the percentage of the solid content mass of hollow particles with respect to the solid content mass of print resin constituting the print layer (unit: mass %) is calculated by substituting the solid content mass of hollow particles, which is applied onto one main surface of the fiber aggregate in order to constitute the print layer during an interior trim surface material preparation process, as B into the above formula, and substituting the solid content mass of print resin, which is applied onto one main surface, as C into the above formula.

Alternatively, the percentage of the solid content mass of hollow particles with respect to the solid content mass of print resin constituting the print layer (unit: mass %) is calculated by substituting the solid content mass of hollow particles contained in a coating liquid, which contains hollow particles and print resin that constitute the print layer, and which is applied onto one main surface of the fiber aggregate in order to constitute the print layer during an interior trim surface material preparation process, as B into the above formula, and substituting the solid content mass of print resin contained in the coating liquid as C into the above formula.

The thickness of the interior trim surface material may be appropriately selected, but it may be 2.5 mm or less, 2.0 mm or less, and 1.4 mm or less. On the other hand, the lower limit of the thickness may be appropriately adjusted, but it is realistic to be 0.5 mm or more. Each lower limit and each upper limit can be arbitrarily combined as desired.

The mass per unit area of the interior trim surface material may be appropriately selected, but it may be 300 g/m² or less, and 250 g/m² or less. On the other hand, the lower limit of the mass per unit area may be appropriately selected, but it is realistic to be 100 g/m² or more. Each lower limit and each upper limit can be arbitrarily combined as desired.

The air permeability of the interior trim surface material may be appropriately selected, but it is preferably 5 cm³/cm²·s or more so that an interior trim surface material with a wide frequency range where a sound absorption effect is expected can be provided. The upper limit may be appropriately selected, but the air permeability is preferably 60 cm³/cm²·s or less so that the sound absorption effect is rich.

The term “air permeability” as used herein means a value measured in accordance with 6.8.1 (Fragile Form Method) stipulated in JIS L1913:2010 “Test methods for nonwovens”.

The interior trim surface material may further comprise other components, such as a porous body, a film, a foam, or the like. These components can be laminated on the main surface different from the main surface containing hollow particles in the interior trim surface material.

Next, the method of producing an interior trim surface material of the present invention will be explained. Explanation is omitted about the points which are the same as the items explained about the interior trim surface material described above.

The method of producing an interior trim surface material of the present invention may be appropriately selected, but as an example, a method of producing an interior trim surface material, comprising the steps of:

(1) providing a fiber aggregate,
(2) mixing a resin capable of constituting a print layer, and hollow particles having an average particle size of 106 μm or less in a solvent or a dispersion medium to prepare a coating liquid,
(3) applying the coating liquid on one main surface of the fiber aggregate, and
(4) heating the fiber aggregate applied with the coating liquid to remove the solvent or the dispersion medium, may be exemplified.

First, “(1) the step of providing a fiber aggregate” will be explained.

A sheet fabric, such as a fiber web, a nonwoven fabric, a woven fabric, a knitted fabric, or the like, is provided as the fiber aggregate.

The fineness and fiber length of the constituent fibers in the fiber aggregate, and the thickness and mass per unit area of the fiber aggregate may be selected from the values described above.

Next, “(2) the step of mixing a resin capable of constituting a print layer, and hollow particles having an average particle size of 106 μm or less in a solvent or a dispersion medium to prepare a coating liquid” will be explained.

The type of the solvent or dispersion medium may be appropriately selected, but it is preferable that a solvent in which the resin capable of constituting a print layer is dissolved, and in which the hollow particles are not dissolved but can be dispersed, or a dispersion medium in which resin particles and hollow particles capable of constituting a print layer are not dissolved but can be dispersed, is selected so that the coating liquid can be preferably applied on one main surface of the fiber aggregate.

In addition to the hollow particles, additives, such as a flame retardant, a fragrance, a pigment, an antibacterial agent, an antifungal agent, photocatalyst particles, an emulsifier, a dispersant, a surfactant, or the like, may be dissolved or dispersed, and contained in the coating liquid.

Further, “(3) the step of applying the coating liquid on one main surface of the fiber aggregate” will be explained.

The method of applying the coating liquid on one main surface of the fiber aggregate may be appropriately selected. A method of spraying or applying the coating liquid, as it is or in a foamed state, on one main surface of the fiber aggregate using a spray, impregnation roll, or the like, a method of immersing one main surface of the fiber aggregate in the coating liquid, or the like, may be selected.

Embodiments of the coating liquid applied on one main surface of the fiber aggregate may be appropriately selected. A method of applying the coating liquid so that the entire main surface is coated with the coating liquid, an applying method by printing or textile printing so as to form a pattern on the main surface, or the like, may be selected. One type of coating liquid may be applied, or multiple types of coating liquids may be applied. When multiple types of coating liquids are applied, the applying embodiment (pattern, and composition of coating liquid) of each coating liquid may be different from each other.

Further, “(4) the step of heating the fiber aggregate applied with the coating liquid to remove the solvent or the dispersion medium” will be explained.

The method of removing a solvent or dispersion medium may be appropriately selected. The solvent or dispersion medium can be evaporated and removed, for example, by heating the applied fiber aggregate with a heater, such as an oven dryer, a far-infrared heater, a dry heat dryer, a hot air dryer, or the like, by standing the applied fiber aggregate under a room temperature atmosphere or reduced pressure atmosphere, or the like.

The heating temperature for removing the solvent or dispersion medium is a temperature at which the solvent or dispersion medium can be volatilized, and the upper limit of heating temperature is selected so as not to unintentionally lower the shape, function, or the like of the components, such as the fiber aggregate, hollow particles, and the like.

When the fiber aggregate is a fiber web, constituent fibers may be bonded to each other (adhered with a melted binder, or adhered by melting a thermoplastic component contained in the constituent fibers) by step (4) to form a nonwoven fabric.

The interior trim surface material of the present invention can be produced using the production method described above.

The above-mentioned method of producing an interior trim surface material may be a method of producing an interior trim surface material comprising various secondary processes, such as a step of laminating other components, such as a porous body, a film, a foam, or the like, a processing step by punching out a shape according to the application or usage, or the like.

These components can be laminated on the main surface different from the main surface containing hollow particles in the interior trim surface material.

Further, the interior trim surface material may be subjected to a step of pressurizing the main surface at the print layer side in order to smooth the surface, such as a reliant press or the like. The method of producing an interior trim surface material comprising this step is preferable, because an interior trim surface material with a surface roughness (SMD) of less than 2.71 μm can be provided.

### EXAMPLES

The present invention now will be further illustrated by, but is by no means limited to, the following Examples.

### (Preparation of Fiber Aggregate)

After 100% of spun-dyed polyester fibers (fineness: 2.2 dtex, fiber length: 38 mm) were opened using a card machine to form a fiber web, the fiber web was subjected to a needle punching treatment from one side of the fiber web at a needle density of 400 needles/m², and was passed between hot rolls (gap spacing: 0.6 mm, roll heating temperature: 165° C.) to prepare a needle punched nonwoven fabric (mass per unit area: 180 g/m², thickness: 1.6 mm).

Next, a binder liquid, which had been formulated in the proportions described below and had been whipped, was applied on the opposite side to the needling side of the needle punched nonwoven fabric. The binder-applied needle punched nonwoven fabric was passed between rolls (gap spacing: 0.25 mm), and dried using a can dryer at a temperature of 160° C. to prepare a binder-bonded nonwoven fabric (mass per unit area: 182 g/m², thickness: 1.6 mm, a nonwoven fabric in which all constituent fibers were randomly entangled).

### Binder Liquid

Acrylic ester resin emulsion (Tg of acrylic ester resin: −40° C., solid content mass of acrylic ester resin emulsion: 50 mass %): 2.3 parts

Thickener: 0.2 parts

Surfactant: 0.2 parts

25% Ammonia water: 0.1 parts

Water: 97.2 parts

### (Preparation of Printing Liquid)

Printing liquids A to F were prepared in the following proportions.

In connection with this, hollow particles formulated in printing liquids A to C and E to F were ones in which an inorganic component was present on the outer periphery of the hollow particles consisting of organic resin. On the other hand, hollow particles formulated in printing liquid D were ones consisting of organic resin alone.

### Printing Liquid A

Acrylic ester resin emulsion (Tg of acrylic ester resin: −40° C., solid content mass of acrylic ester resin emulsion: 50 mass %): 10 parts

Hollow particles (Matsumoto Microsphere (registered trademark) MFL-100MCA, Matsumoto Yushi-Seiyaku Co., Ltd., coefficient of thermal expansion: 112.3%, solid content mass of hollow particles: 100 mass %): 2 parts

Thickener (solid content mass: 100 mass %): 0.405 parts

Defoamer (solid content mass: 17 mass %): 0.4 parts

25% Ammonia water: 1 part

Thickener (solid content mass: 28 mass %): 1.5 parts

Softener (solid content mass: 41 mass %): 3 parts

Water: 81.695 parts

### Printing Liquid B

Acrylic ester resin emulsion (Tg of acrylic ester resin: −40° C., solid content mass of acrylic ester resin emulsion: 50 mass %): 10 parts

Hollow particles (Matsumoto Microsphere (registered trademark) MFL-110CAL, Matsumoto Yushi-Seiyaku Co., Ltd., coefficient of thermal expansion: 100.5%, solid content mass of hollow particles: 100 mass %): 2 parts

Thickener (solid content mass: 100 mass %): 0.405 parts

Defoamer (solid content mass: 17 mass %): 0.4 parts

25% Ammonia water: 1 part

Thickener (solid content mass: 28 mass %): 1.5 parts

Softener (solid content mass: 41 mass %): 3 parts

Water: 81.695 parts

### Printing Liquid C

Acrylic ester resin emulsion (Tg of acrylic ester resin: −40° C., solid content mass of acrylic ester resin emulsion: 50 mass %): 5 parts

Hollow particles (Matsumoto Microsphere (registered trademark) MFL-100MCA, Matsumoto Yushi-Seiyaku Co., Ltd., coefficient of thermal expansion: 112.3%, solid content mass of hollow particles: 100 mass %): 1 part

Thickener (solid content mass: 100 mass %): 0.405 parts

Defoamer (solid content mass: 17 mass %): 0.4 parts

25% Ammonia water: 1 part

Thickener (solid content mass: 28 mass %): 1.5 parts

Softener (solid content mass: 41 mass %): 1.5 parts

Water: 89.195 parts

### Printing Liquid D

Acrylic ester resin emulsion (Tg of acrylic ester resin: −40° C., solid content mass of acrylic ester resin emulsion: 50 mass %): 10 parts

Hollow particles (Matsumoto Microsphere (registered trademark) FN-180, Matsumoto Yushi-Seiyaku Co., Ltd., coefficient of thermal expansion: 300% or more, solid content mass of hollow particles: 100 mass %): 2 parts

Thickener (solid content mass: 100 mass %): 0.405 parts

Defoamer (solid content mass: 17 mass %): 0.4 parts

25% Ammonia water: 1 part

Thickener (solid content mass: 28 mass %): 1.5 parts

Softener (solid content mass: 41 mass %): 3 parts

Water: 81.695 parts

### Printing Liquid E

Acrylic ester resin emulsion (Tg of acrylic ester resin: −40° C., solid content mass of acrylic ester resin emulsion: 50 mass %): 10 parts

Hollow particles (Matsumoto Microsphere (registered trademark) MFL-81GCA, Matsumoto Yushi-Seiyaku Co., Ltd., coefficient of thermal expansion: 113.8%, solid content mass of hollow particles: 100 mass %): 2 parts

Thickener (solid content mass: 100 mass %): 0.405 parts

Defoamer (solid content mass: 17 mass %): 0.4 parts

25% Ammonia water: 1 part

Thickener (solid content mass: 28 mass %): 1.5 parts

Softener (solid content mass: 41 mass %): 3 parts

Water: 81.695 parts

### Printing Liquid F

Acrylic ester resin emulsion (Tg of acrylic ester resin: −40° C., solid content mass of acrylic ester resin emulsion: 50 mass %): 10 parts

Hollow particles (Matsumoto Microsphere (registered trademark) MFL-SEVEN, Matsumoto Yushi-Seiyaku Co., Ltd., coefficient of thermal expansion: 82.7%, solid content mass of hollow particles: 100 mass %): 2 parts

Thickener (solid content mass: 100 mass %): 0.405 parts

Defoamer (solid content mass: 17 mass %): 0.4 parts

25% Ammonia water: 1 part

Thickener (solid content mass: 28 mass %): 1.5 parts

Softener (solid content mass: 41 mass %): 3 parts

Water: 81.695 parts

### Example 1

On the binder-applied surface of the binder-bonded nonwoven fabric, printing liquid A was applied using a cylinder, and dried using a dryer at a temperature of 150° C.

Finally, the nonwoven fabric was subjected to a fusing press machine (temperature: 150° C., press pressure: 2 kgf, processing time: 12 seconds) to prepare an interior trim surface material (mass per unit area: 212 g/m², thickness: 1.3 mm, air permeability: 46.1 cc/cm²/sec, mass per unit area of a print layer: 30 g/m², average particle size of hollow particles: 73.0 μm, CV value: 8.4%) with a print layer derived from printing liquid A on one main surface of the binder-bonded nonwoven fabric.

With respect to the main surface on which the print layer was exposed in the interior trim surface material prepared in this way, the SMD was 2.09 μm, MIU was 0.45, and MMD was 0.015.

### Example 2

An interior trim surface material (mass per unit area: 212 g/m², thickness: 1.4 mm, air permeability: 55.5 cc/cm²/sec, mass per unit area of a print layer: 30 g/m², average particle size of hollow particles: 105.6 μm, CV value: 15.9%) with a print layer derived from printing liquid B on one main surface of the binder-bonded nonwoven fabric was prepared in the same manner as in Example 1, except that printing liquid B was used instead of printing liquid A.

With respect to the main surface on which the print layer was exposed in the interior trim surface material prepared in this way, the SMD was 2.21 μm, MIU was 0.45, and MMD was 0.015.

### Comparative Example 1

The binder-bonded nonwoven fabric without being processed was regarded as an interior trim surface material (mass per unit area: 182 g/m², thickness: 1.8 mm, air permeability: 79.2 cc/cm²/sec) without a print layer.

With respect to the main surface at the binder-applied surface side in the interior trim surface material prepared in this way, the SMD was 3.39 μm, MIU was 0.36, and MMD was 0.013.

### Comparative Example 2

The binder-bonded nonwoven fabric was subjected to a fusing press machine (temperature: 150° C., press pressure: 2 kgf, processing time: 12 seconds) to prepare an interior trim surface material (mass per unit area: 182 g/m², thickness: 1.3 mm, air permeability: 69.9 cc/cm²/sec) without a print layer.

With respect to the main surface at the binder-applied surface side in the interior trim surface material prepared in this way, the SMD was 2.71 μm, MIU was 0.36, and MMD was 0.012.

### Comparative Example 3

On the binder-applied surface of the binder-bonded nonwoven fabric, printing liquid D was applied using a cylinder, and dried using a dryer at a temperature of 150° C. to prepare an interior trim surface material (mass per unit area: 212 g/m², thickness: 1.4 mm, air permeability: 52.8 cc/cm²/sec, mass per unit area of a print layer: 30 g/m², average particle size of hollow particles: 121.0 μm, CV value: 28.1%) with a print layer derived from printing liquid D on one main surface of the binder-bonded nonwoven fabric.

With respect to the main surface on which the print layer was exposed in the interior trim surface material prepared in this way, the SMD was 2.97 μm, MIU was 0.27, and MMD was 0.012.

### Comparative Example 4

An interior trim surface material (mass per unit area: 212 g/m², thickness: 1.4 mm, air permeability: 59.7 cc/cm²/sec, mass per unit area of a print layer: 30 g/m², average particle size of hollow particles: 151.7 μm, CV value: 17.2%) with a print layer derived from printing liquid D on one main surface of the binder-bonded nonwoven fabric was prepared in the same manner as in Example 1, except that printing liquid D was used instead of printing liquid A.

With respect to the main surface on which the print layer was exposed in the interior trim surface material prepared in this way, the SMD was 2.88 μm, MIU was 0.20, and MMD was 0.010.

### Comparative Example 5

An interior trim surface material (mass per unit area: 212 g/m², thickness: 1.3 mm, air permeability: 46.3 cc/cm²/sec, mass per unit area of a print layer: 30 g/m², average particle size of hollow particles: 17.1 μm, CV value: 8.5%) with a print layer derived from printing liquid E on one main surface of the binder-bonded nonwoven fabric was prepared in the same manner as in Example 1, except that printing liquid E was used instead of printing liquid A.

With respect to the main surface on which the print layer was exposed in the interior trim surface material prepared in this way, the SMD was 2.31 μm, MIU was 0.16, and MMD was 0.010.

### Example 3

An interior trim surface material (mass per unit area: 212 g/m², thickness: 1.1 mm, air permeability: 42.4 cc/cm²/sec, mass per unit area of a print layer: 30 g/m², average particle size of hollow particles: 73.0 μm, CV value: 8.4%) with a print layer derived from printing liquid A on one main surface of the binder-bonded nonwoven fabric was prepared in the same manner as in Example 1, except that the processing time of a fusing press machine was changed to 20 seconds.

With respect to the main surface on which the print layer was exposed in the interior trim surface material prepared in this way, the SMD was 1.98 μm, MIU was 0.44, and MMD was 0.012.

### Example 4

An interior trim surface material (mass per unit area: 202 g/m², thickness: 1.3 mm, air permeability: 49.7 cc/cm²/sec, mass per unit area of a print layer: 20 g/m², average particle size of hollow particles: 73.0 μm, CV value: 8.4%) with a print layer derived from printing liquid C on one main surface of the binder-bonded nonwoven fabric was prepared in the same manner as in Example 1, except that printing liquid C was used instead of printing liquid A.

With respect to the main surface on which the print layer was exposed in the interior trim surface material prepared in this way, the SMD was 2.14 μm, MIU was 0.49, and MMD was 0.015.

### Example 5

An interior trim surface material (mass per unit area: 202 g/m², thickness: 1.1 mm, air permeability: 46.8 cc/cm²/sec, mass per unit area of a print layer: 20 g/m², average particle size of hollow particles: 73.0 μm, CV value: 8.4%) with a print layer derived from printing liquid C on one main surface of the binder-bonded nonwoven fabric was prepared in the same manner as in Example 4, except that the processing time of a fusing press machine was changed to 20 seconds.

With respect to the main surface on which the print layer was exposed in the interior trim surface material prepared in this way, the SMD was 2.02 μm, MIU was 0.48, and MMD was 0.015.

### Comparative Example 6

An interior trim surface material (mass per unit area: 202 g/m², thickness: 1.8 mm, air permeability: 60.1 cc/cm²/sec, mass per unit area of a print layer: 20 g/m², average particle size of hollow particles: 24.8 μm, CV value: 14.3%) with a print layer derived from printing liquid F on one main surface of the binder-bonded nonwoven fabric was prepared in the same manner as in Example 1, except that printing liquid F was used instead of printing liquid A.

With respect to the main surface on which the print layer was exposed in the interior trim surface material prepared in this way, the SMD was 2.62 μm, MIU was 0.17, and MMD was 0.010.

### Comparative Example 7 and Examples 6 to 8

Interior trim surface materials with a print layer derived from printing liquid C on one main surface of the binder-bonded nonwoven fabric was prepared in the same manner as in Example 4, except that the proportion of hollow particles formulated in printing liquid C was changed and, in accordance with the change, the proportion of water was changed so that the total of constituent components of the print liquid became 100 parts.

The specifications of the print layers in the interior trim surface materials prepared in Comparative Example 7 and Examples 6 to 8, and the properties of the interior trim surface materials are shown in Table 1.

TABLE 1

| | | Comp. 7 | Ex. 6 | Ex. 7 | Ex. 8 | Ex. 4 |
|---|---|---|---|---|---|---|
| Print layer | Mass per unit are (g/m²) | 20 | 20 | 20 | 20 | 20 |
| | Average particle size of hollow particles | 73.0 | 73.0 | 73.0 | 73.0 | 73.0 |
| | (μm) | | | | | |
| | CV value (%) | 8.4 | 8.4 | 8.4 | 8.4 | 8.4 |
| | Solid content mass of hollow particles with | 0 | 25 | 28 | 30 | 40 |
| | respect to solid content mass of resin | | | | | |
| | constituting print layer (mass %) | | | | | |
| Interior trim | Mass per unit are (g/m²) | 202 | 202 | 202 | 202 | 202 |
| surface material | Thickness (mm) | 1.2 | 1.2 | 1.3 | 1.3 | 1.3 |
| | Air permeability (cc/cm²/sec) | 61.5 | 55.1 | 50.9 | 54.7 | 49.7 |
| | SMD of main surface on which print layer | 2.32 | 2.68 | 2.60 | 2.05 | 2.14 |
| | is exposed | | | | | |
| | MIU of main surface on which print layer | 0.23 | 0.39 | 0.57 | 0.52 | 0.49 |
| | is exposed | | | | | |
| | MMD of main surface on which print layer | 0.009 | 0.014 | 0.020 | 0.018 | 0.015 |
| | is exposed | | | | | |

By having 8 monitors touch the main surface (the main surface on which the print layer is exposed for Examples 1 to 8 and Comparative Examples 3 to 7, and the main surface at the binder-applied surface side for Comparative Examples 1 and 2) of each interior trim surface material prepared in Examples and Comparative Examples as described above, the texture when touching was evaluated based on whether or not a smooth and fine texture was felt, and based on a moist feeling by feeling of resistance or sliminess at a five-point scale.

In connection with this, when 6 or more of the 8 monitors felt a smooth and fine texture, the evaluated interior trim surface material was evaluated as having a smooth and fine texture. On the other hand, in other cases, the evaluated interior trim surface material was evaluated as not having a smooth and fine texture.

A sensation of high moistness by a feeling of resistance or sliminess when touching the main surface at the binder-applied surface side of the interior trim surface material of Comparative Example 1 was regarded as “3”, and when the sensation was felt high, it was evaluated as “4”, and when the sensation was felt higher, it was evaluated as “5”. On the other hand, when the sensation was felt low, it was evaluated as “2”, and when the sensation was felt lower, it was evaluated as “1”.

Further, when the sensation was felt higher than “3” and lower than “4”, it was evaluated as “3.5”; when the sensation was felt higher than “4” and lower than “5”, it was evaluated as “4.5”; when the sensation was felt lower than “3” and higher than “2”, it was evaluated as “2.5”; and when the sensation was felt lower than “2” and higher than “1”, it was evaluated as “1.5”.

Then, the average of values evaluated by 8 monitors was rounded off to one decimal place, and regarded as an evaluation point for a moist feeling by feeling of resistance or sliminess.

The results are shown in Tables 2 and 3.

TABLE 2

| | Ex. 1 | Ex. 2 | Ex. 3 | Ex. 4 | Ex. 5 |
|---|---|---|---|---|---|
| Whether or not the texture is smooth | ∘ | ∘ | ∘ | ∘ | ∘ |
| and fine | | | | | |
| Evaluation point of moist feeling by | 4.5 | 4.4 | 3.7 | 3.8 | 3.9 |
| feeling of resistance or sliminess | | | | | |

| | Comp. 1 | Comp. 2 | Comp. 3 | Comp. 4 | Comp. 5 | Comp. 6 |
|---|---|---|---|---|---|---|
| Whether or not the texture is smooth | x | x | x | x | x | x |
| and fine | | | | | | |
| Evaluation point of moist feeling by | 3.0 | 3.2 | 2.9 | 3.0 | 3.4 | 3.4 |
| feeling of resistance or sliminess | | | | | | |

∘: A smooth and fine texture was felt.
x: A smooth and fine texture was not felt.

TABLE 3

| | Comp. 7 | Ex. 6 | Ex. 7 | Ex. 8 | Ex. 4 |
|---|---|---|---|---|---|
| Solid content mass of hollow | 0 | 25 | 28 | 30 | 40 |
| particles with respect to solid | | | | | |
| content mass of resin | | | | | |
| constituting print layer (mass %) | | | | | |
| Whether or not the texture is | x | ∘ | ∘ | ∘ | ∘ |
| smooth and fine | | | | | |
| Evaluation point of moist | 2.4 | 3.6 | 4.3 | 4.6 | 3.8 |
| feeling by feeling of | | | | | |
| resistance or sliminess | | | | | |

∘: A smooth and fine texture was felt.
x: A smooth and fine texture was not felt.

It was found from the evaluation results that while still imparting a sensation that feels smooth and fine texture, the interior trim surface materials of the Examples had an excellent texture, such as a feeling of high moistness, by imparting a feeling of resistance or sliminess in comparison to the Comparative Examples.

On the other hand, the interior trim surface materials of the Comparative Examples did not impart a sensation that feels smooth and fine texture, and had a poor texture that impart a feeling of low moistness.

Further, it was found from the results shown in Table 3 that, in comparison to the interior trim surface material of Example 6 in which the percentage of the solid content mass of hollow particles with respect to the solid content mass of print resin constituting the print layer was 25 mass %, the interior trim surface materials of Examples 7, 8, and 4 having a higher percentage were ones that imparted a feeling of higher moistness by imparting a feeling of resistance or sliminess.

Therefore, it was found that an interior trim surface material having a more excellent texture can be provided by an interior trim surface material having a percentage of more than 25 mass %.

### INDUSTRIAL APPLICABILITY

Since the interior trim surface material of the present invention has a more excellent texture, it can be suitably used for automotive applications, such as a headlining, a door side, a pillar garnish, a rear package, or the like; interior applications, such as partitions or the like; or building material applications, such as wall covering materials or the like.

1. An interior trim surface material comprising a print layer on at least one main surface of a fiber aggregate, wherein the main surface on which the print layer is exposed in the interior trim surface material has a surface roughness (SMD) of less than 2.71 μm and an average frictional coefficient (MIU) of more than 0.27, and the print layer contains hollow particles having an average particle size of 106 μm or less.
